(19) United States
(12) Patent Application Publication
(10) Pub. No.: US 2014/0310642 A1
(43) Pub. Date: Oct. 16, 2014

(54) DEFERRED PLACEMENT PROMPT

(71) Applicant: MICROSOFT CORPORATION, Redmond, WA (US)

(72) Inventors: Miron Vranjes, Seattle, WA (US); Jesse Clay Satterfield, Seattle, WA (US); Matthew Isaac Worley, Bellevue, WA (US); Chaitanya Sareen, Seattle, WA (US); Nils Anders Sundelin, Bothell, WA (US); Richie Fang, Bellevue, WA (US); Alice Steinglass, Bellevue, WA (US); Robert James Jarrett, Seattle, WA (US); Kaikai Wang, Carnation, WA (US)

(73) Assignee: MICROSOFT CORPORATION, Redmond, WA (US)

(21) Appl. No.: 13/862,481

(22) Filed: Apr. 15, 2013

(51) Int. Cl. G06F 3/0481

(52) U.S. Cl. CPC G06F 3/0481
USPC 715/781

(57) ABSTRACT

A deferred placement prompt is provided in a user interface when an application window is launched. Responsive to the presentation of the deferred placement prompt, the user can provide a directional placement instruction (e.g., a “drag” of the prompt, a selection of a screen region, a keyboard input) to indicate the user's preference for placement of the launched window. The user interface can give cooperative feedback to the user during the deferred placement prompt operation, such as highlighting an application window to be replaced, responsive to a directional placement instruction, animating the deferred placement prompt, etc.

### BACKGROUND

A computer operating system, including its corresponding user interface, allows a user to launch an application window for presentation to the user through the user interface. However, the computer operating system does not typically give the user input into the initial placement of the launched application window. Instead, the computer operating system typically uses a somewhat arbitrary placement or a placement dependent upon a previous placement of a window of the same application or the current layout of the user interface. In these approaches, the window is presented before the user can move and re-size the window. These approaches do not provide an opportunity for the user to provide placement input before the window is presented to the user.

### SUMMARY

Implementations described and claimed herein address the foregoing problems by providing a deferred placement prompt when an application window is launched. Responsive to the presentation of the deferred placement prompt, the user can provide a directional placement instruction (e.g., a “drag” of the prompt, a selection of a screen region, a keyboard input) to indicate the user's preference for placement of the launched window. The user interface can give cooperative feedback to the user during the deferred placement prompt operation, such as highlighting an application window to be replaced, responsive to a directional placement instruction, animating the deferred placement prompt, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates two application windows in an example user interface screen supported by a deferred placement prompt feature.

FIG. 2 illustrates a Start screen of an example user interface supported by a deferred placement prompt feature.

FIG. 3 illustrates an example sequence of user interface operations implementing a deferred placement prompt, initiated from selection of an application launch control.

FIG. 4 illustrates another example sequence of user interface operations implementing a deferred placement prompt, initiated from notification from an application.

FIG. 5 illustrates example operations for implementing a deferred placement prompt.

FIG. 6 illustrates an example system that may be useful in implementing the described technology.

### DETAILED DESCRIPTION

Launching an application window includes without limitation initially executing the application and switching to a new or hidden application window of an already executing application. In addition, an application window may include without limitation a window of the operating system components, an operating system utility, and a special purpose application program (e.g., a Web browser program, a word processing program, a spreadsheet program).

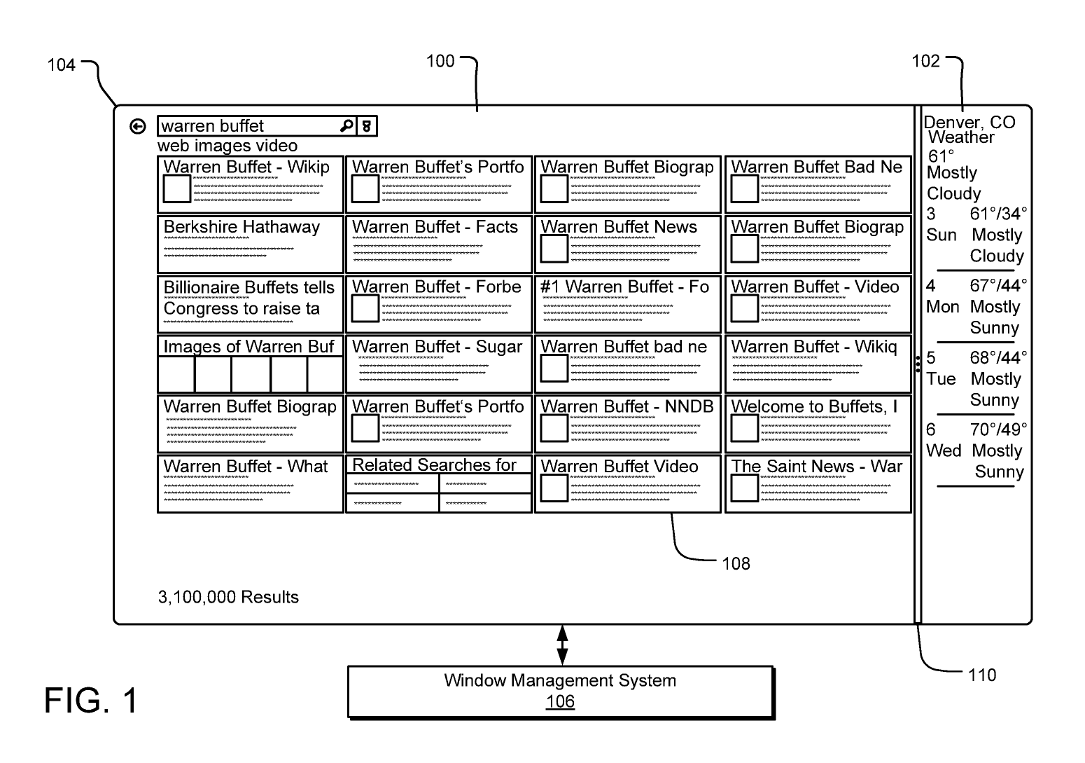

FIG. 1 illustrates two application windows 100 and 102 in an example user interface screen 104 supported by a deferred placement prompt feature. A window management system 106 is typically a component of an operating system or user interface environment but could also be an independent application. The window management system 106 manages the display, placement, layout, appearance, and other aspects of the application windows 100 and 102, as well as other windows and user interface characteristics and operations.

The application window 100 presents a search result window displaying search results from a Web search engine. The individual search results (such as a search result 108) includes representative text and/or one or more images along with a browser navigable link, which can be selected by the user for navigation to a Web site identified by the browser navigable link. The application window 102 presents results from a weather application or Web site, including a 4-day forecast of weather in Denver, Colo. A window boundary control 110 divides the displayed area of the application window 100 and displayed area of the application window 102, in the illustrated case, separating the application windows. In some implementations, the window boundary control 110 may be manipulated by the user to change the size and/or location of one or both windows.

The application windows 100 and 102 are shown in FIG. 1 as being non-overlapping windows. However, the described technology is not limited to non-overlapping windowing environments. For example, in such environments, each application window in an overlapping windowing environment may be bounded by a window boundary control, which can be manipulated by the user to change the location, size, and front-to-back ordering (collectively, “placement”) of the potentially overlapping windows (e.g., the z-ordering of the windows). The window management system 106 receives input through the application windows 100 and 102 and through other user interface components (e.g., the keyboard interface, a touch screen interface, a voice interface, and pointing device) and displays the applications windows 100 and 102, the window boundary control 110, and other application windows and controls through the user interface.

In one implementation, an event triggers a launch of an application window via the window management system 106. For example, in one implementation, a user can select a browser-navigable link from the search result 108, which launches a browser window displaying the Web page designated by the link. In another example, the user selects an application from a system file search window, a Start screen, or a Start menu to launch a corresponding application window. In yet another example, a viewable notification may appear within the user interface in response to a system alert, a time-based reminder, etc., the user-selection of which launches an associated application window. Other examples of event-triggered launches are contemplated.

When an application window is launched, the window management system 106 attempts to determine a placement within the user interface with which to display the application window. For example, some application windows are characterized by predefined display parameters (e.g., full screen, a left portion of the screen, at least half the screen, etc.). Some predefined characteristics may provide no constraints or some constraints (e.g., a minimum size) but otherwise leave the window placement up to the window management system 106.

It should be noted that placement can be aborted. For example, if the deferred placement prompt is dragged off screen or a particular keyboard input is provided, the window management system 106 can be left to determine placement the best it can or even the launch of the new application window may be aborted. This operation may be referred to as dismissal.

Various conditions may result in presentation of a deferred placement prompt through the user interface. For example, a deferred placement prompt may be a default launching feature for all or certain applications. Alternatively, a deferred placement prompt may be triggered according to a user setting or forced by user input (e.g., a predefined gesture or keyboard input). In yet another example, the window management system 106 may present a deferred placement prompt when its default window placement algorithm results in an ambiguity about where to place the newly launched window—so it prompts the user to provide guidance using a deferred placement prompt and a directional placement instruction.

In circumstances in which the window management system 106 has options for placement of the launched application window, the window management system 106 can present a deferred placement prompt (not shown in FIG. 1) to the user via the user interface. The deferred placement prompt solicits input from the user to assist the window management system 106 in launching the application window within the layout of the user interface. For example, by dragging the deferred placement prompt to the right of the window boundary control 110, the user can indicate to the window management system 106 to display the launched application window in place of the application window 100.

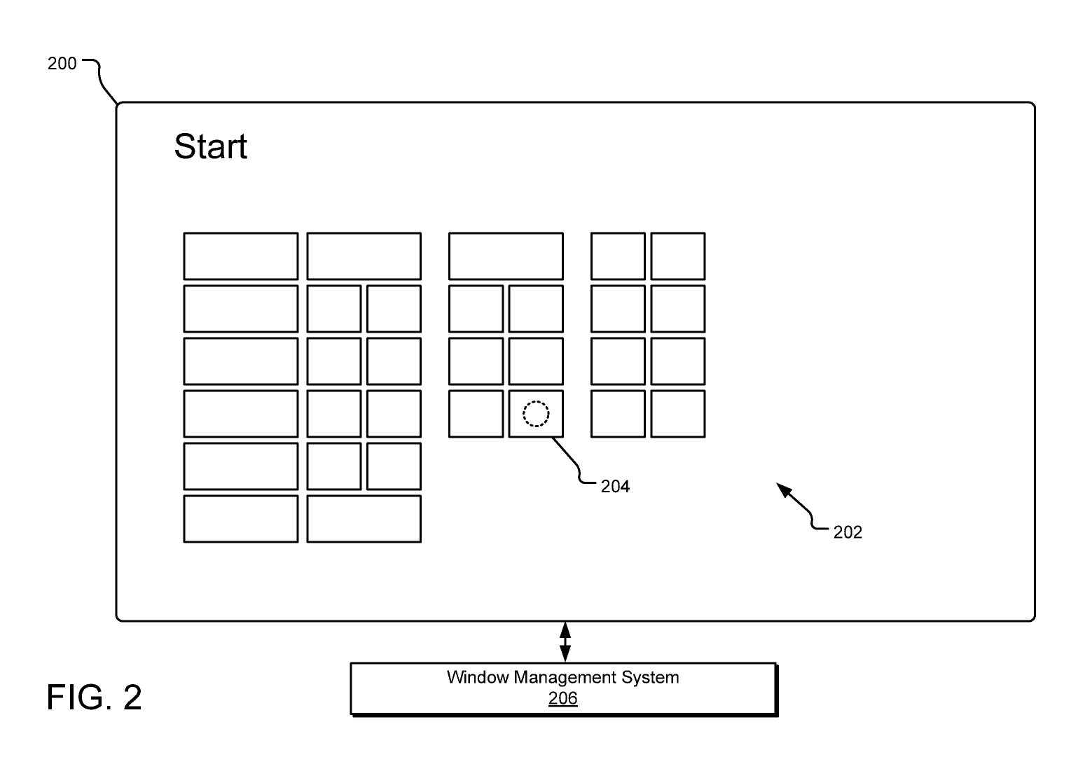

FIG. 2 illustrates a Start screen 200 of an example user interface supported by a deferred placement prompt feature. The Start screen 200 presents a number of launch controls 202 that can be selected to launch an associated application window. For example, if the user selects (e.g., via a touch screen) a launch control 204, a window management system 206 transitions the user interface to a screen capable of displaying executing application (referred to as an “application screen”) in order to launch the application window. In FIG. 2, the selection of the launch control 204 is indicated by the dashed-line circle depicted on the launch control 204. However, in the illustrated example, the window management system 206 does not have enough information to size and locate the associated application window. Accordingly, the window management system 206 transitions to the application screen and presents a deferred placement prompt (not shown in FIG. 2) to the user to solicit user input for the placement of the launched application window.

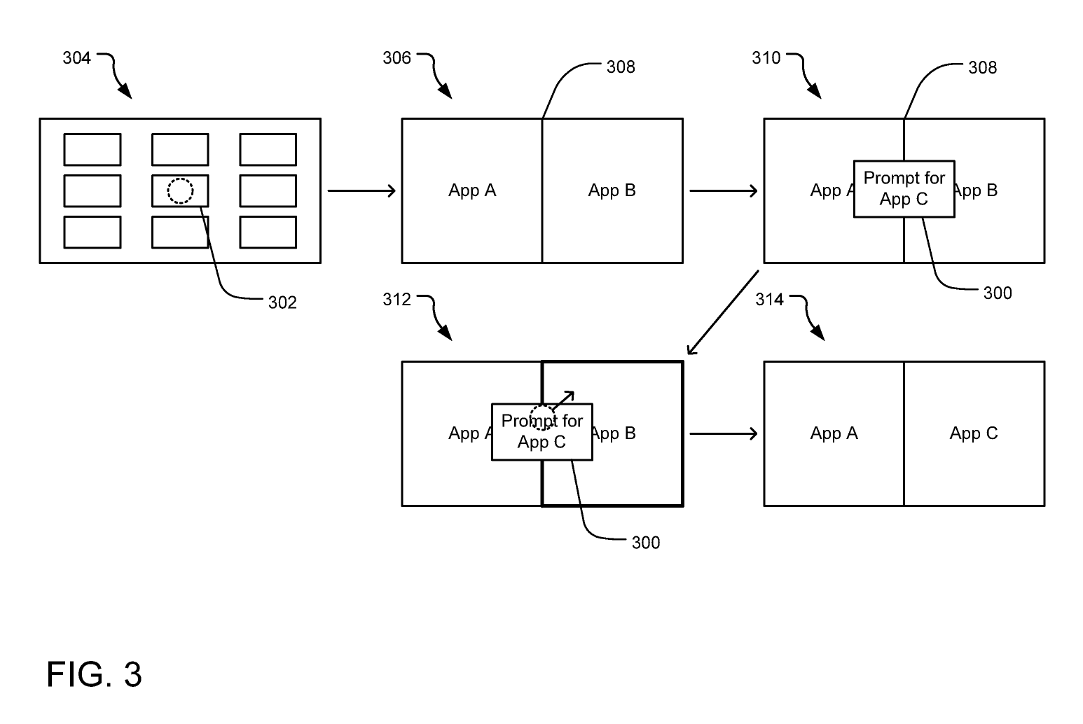

FIG. 3 illustrates an example sequence of user interface operations implementing a deferred placement prompt 300, initiated from selection of an application launch control 302. The application launch control 302 is presented to a user through a Start screen shown at 304 or some other launch interface. The user selects (as indicated by the dashed-line circle) a launch control 302 associated with an application referred to as App C. An application screen 306 shows that windows for applications App A and App B are already presented in the application screen shown at 306, separated by a window boundary control 308.

A window management system receives the user input representing the selection to launch an application window for application C and determines that it has placement options for which it can solicit user input. For example, the window display parameters for a window of App C merely designated a minimum size for the window. Accordingly, the window management system presents the deferred placement prompt 300 in the application screen shown at 310. In one implementation, the deferred placement prompt 300 appears to “float” over the window boundary control 308, although it can be presented in a different size, shape, and location within the user interface. The term “float” suggests a slight animation (e.g., a slight back-and-forth horizontal movement, a slight up-and-down vertical movement, a slight repetitive clockwise-counterclockwise rotation, a slight apparent tilting in and out of the screen plane, a blinking prompt boundary, a blinking prompt, etc.) to indicate to the user that user-input is expected.

In the implementation illustrated in FIG. 3, the application windows do not occlude one another, such that the application windows presented in the application screen do not overlap. However, the described technology may also be used in windowing environments that allow the overlapping of windows within the same application screen. It should also be understood that the deferred placement prompt may be interactive or non-interactive. For example, the deferred placement prompt may be an iconic thumbnail representing the application, a live thumbnail representing the application, or any other interactive or static representation of the application that can be directed for placement of an associated application window using a directional placement instruction.

The deferred placement prompt 300 may be manipulated by the user using a directional placement instruction, which can be input through the user interface in a variety of ways. For example, via a touch screen or a pointing device, the user may “drag” the deferred placement prompt 300 to indicate a desired placement. As shown in the application screen at 312, a user has selected the deferred placement prompt 300 and dragged it to the right. Responsive to receipt of this directional placement instruction, the window management system highlights the boundary of the application window for App B to indicate that it is interpreting the instruction as an instruction to replace the application window for App B with the application window for App C. If the user commits to this instructions (e.g., by releasing the button on the pointing device or removing his or her finger from the touch screen) while the application window for App B is highlighted, the window management system removes the deferred placement prompt 300 from the user interface and replaces the application window for the App B with the newly launched application window for the App C, as shown at 314.

While dragging (whether by touch, by a point device, etc.) is presented as an example of a directional placement instruction, other such instructions are contemplated. For example, a user may issue a directional placement instruction by selecting (whether by touch, by a point device, by keyboard, etc.) the application window he or she wishes to be replaced. In another example, the user may select a portion of the deferred placement prompt that overlays the application window he or she wishes to be replaced. In yet another example, the user may gesture to or from a boundary of the application screen to indicate the desired placement, responsive to presentation of the deferred placement prompt. Further, the deferred placement prompt may be explicitly dismissed (e.g., by predefined keyboard input, such as selecting the ESC key), at which point the window management system removes the deferred placement prompt from the application screen, or implicitly dismissed (e.g., allowing an associated timer to time out), at which point the window management system removes the deferred placement prompt from the application screen.

The representation of the deferred placement prompt can take a variety of forms. For example, a deferred placement prompt may be presented as a notification from an application not concurrently visible in the user interface. In another example, a deferred placement prompt may be presented as an iconic thumbnail control (e.g., when execution of the associated application has not yet been initiated). An example of an iconic thumbnail control may include without limitation a control displaying an icon identifying the associated application (e.g., a clock icon representing a timer application). In yet another example, a deferred placement prompt may be presented as a static or live thumbnail control (e.g., when the execution of the associated application has already been initiated). Various combinations of these and other forms may be employed.

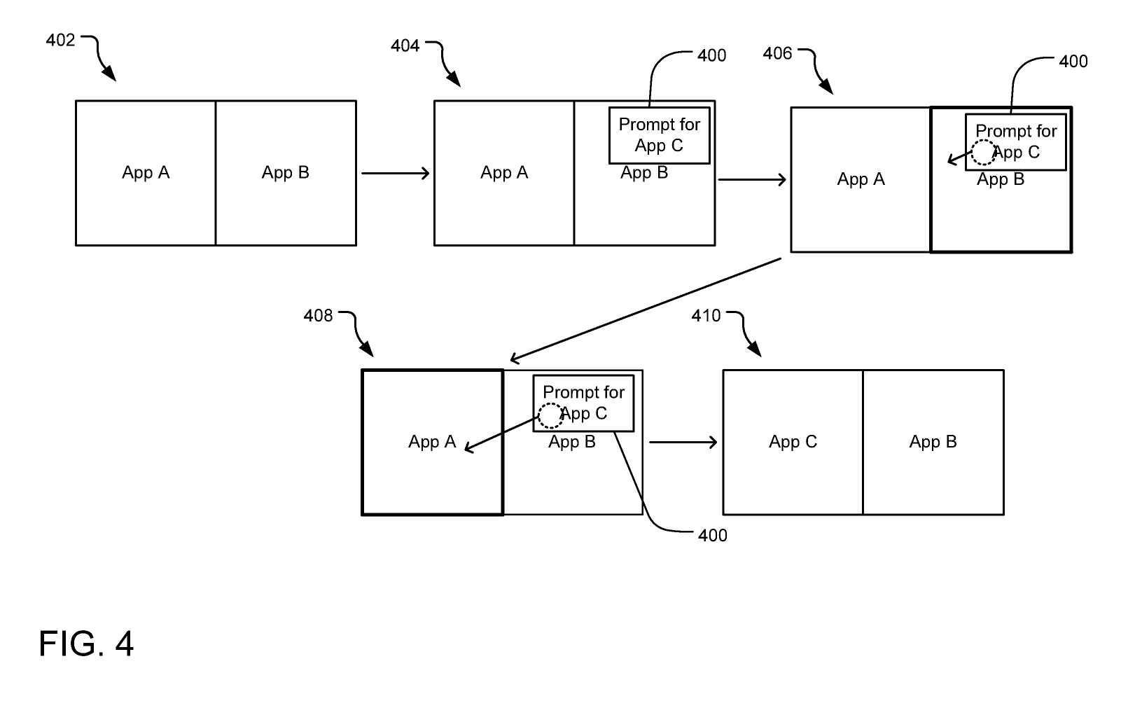

FIG. 4 illustrates another example sequence of user interface operations implementing a deferred placement prompt 400, initiated from notification from an application (referred to as App C). The application screen shown at 402 presents application windows for application App A and App B. The application screen shown at 404 shows an application notification (e.g., a calendar reminder) presented in the application screen by the window management system as a deferred placement prompt 400. As shown at 406, the user begins to provide a directional placement instruction (as indicated by the dashed-line circle and arrow) by dragging the deferred placement prompt 400, and the window management system highlights the boundary of the application window for App B to indicate that it is interpreting the instruction as an instruction to replace the application window for App B with the application window for App C. If the user commits to this instruction (e.g., by releasing the button on the pointing device or removing his or her finger from the touch screen) while the application window for App B is highlighted, the window management system removes the deferred placement prompt 400 from the user interface and replaces the application window for the App B with the newly launched application window for the App C.

However, as shown at 408, the user continues to drag the deferred placement prompt 400 into the window for App A. Accordingly, the window management system removes the highlight of the boundary of the application window for App B and highlights the boundary of the application window for App A to indicate that it is interpreting the instruction as an instruction to replace the application window for App A with the application window for App C. If the user commits to this instruction (e.g., by releasing the button on the pointing device or removing his or her finger from the touch screen) while the application window for App A is highlighted, the window management system removes the deferred placement prompt 400 from the user interface and replaces the application window for the App A with the newly launched application window for the App C, as shown at 410.

In one implementation, the deferred placement prompt 400 may also be used to insert an application window between two visible application windows. For example, rather than having only a choice to replace the window for App A or the window for App B, the deferred placement prompt 400 can be dragged and hovered (an example directional placement instruction) over the divider between the application windows for App A and App B. In response to this user interface activity, the applications windows for App A and App B resize to become smaller, opening a space between them into which the application window for App C can be placed by the user committing to the placement (e.g., removing a finger from the touch screen, releasing a pointer device button, providing a keyboard input). In this implementation, the application window for App A would be presented on the right side of the application screen, the application window for App C would be presented in the middle of the application screen, and the application window for App B would be presented on the right side of the application screen. Other operations and user interface feedback from inserting a window between two windows may also be employed.

In an alternative implementation, the notification may be presented in the application screen not as a deferred placement prompt but as a mere notification (e.g., an instant messaging notification associated with an instant messaging application window that is not currently presented on-screen). In such an implementation, the user may select the notification (e.g., via a touch, a pointer device selection, or keyboard input), which causes the window management system to present a deferred placement prompt as shown starting at 310 in FIG. 3, which operates as described with regard to the descriptions relating to 310, 312, and 314 of FIG. 3.

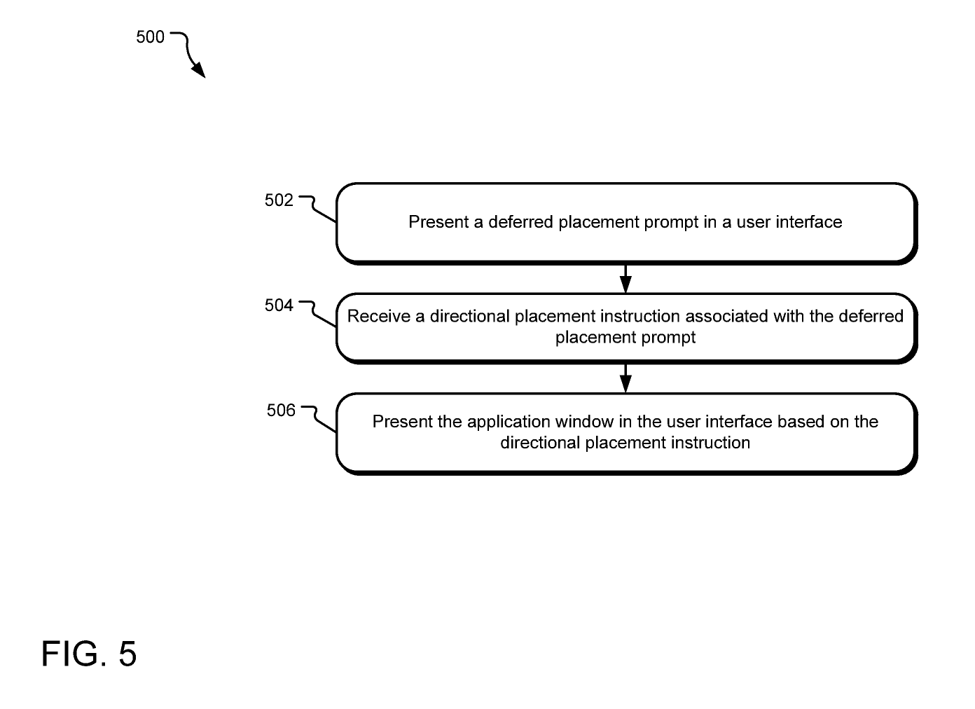

FIG. 5 illustrates example operations 500 for implementing a deferred placement prompt. A presenting operation 502 presents a deferred placement prompt in a user interface. The deferred placement prompt is associated with an application window that is to be displayed to the user within the user interface. In various implementations, the presentation operation 502 may be responsive to a launch event, including without limitation events such as receiving a selection of a launch control associated with the application window, receiving a selection of a notification from an application not concurrently visible in an application window of the user interface.

A receiving operation 504 receives a directional placement instruction associated with the deferred placement prompt. The directional placement instruction may include, for example, a drag of the deferred placement prompt, keyboard or touch input associated with the deferred placement prompt, a selection of another application window to be replaced by the application window associated with the deferred placement prompt, or a selection of a portion of the deferred placement prompt overlaying another application window to be replaced by the application window associated with the deferred placement prompt.

Another presenting operation 506 presents the application window in the user interface based on the directional placement instruction. In one implementation, the application window is displayed in place of another application window indicated by the deferred placement instruction.

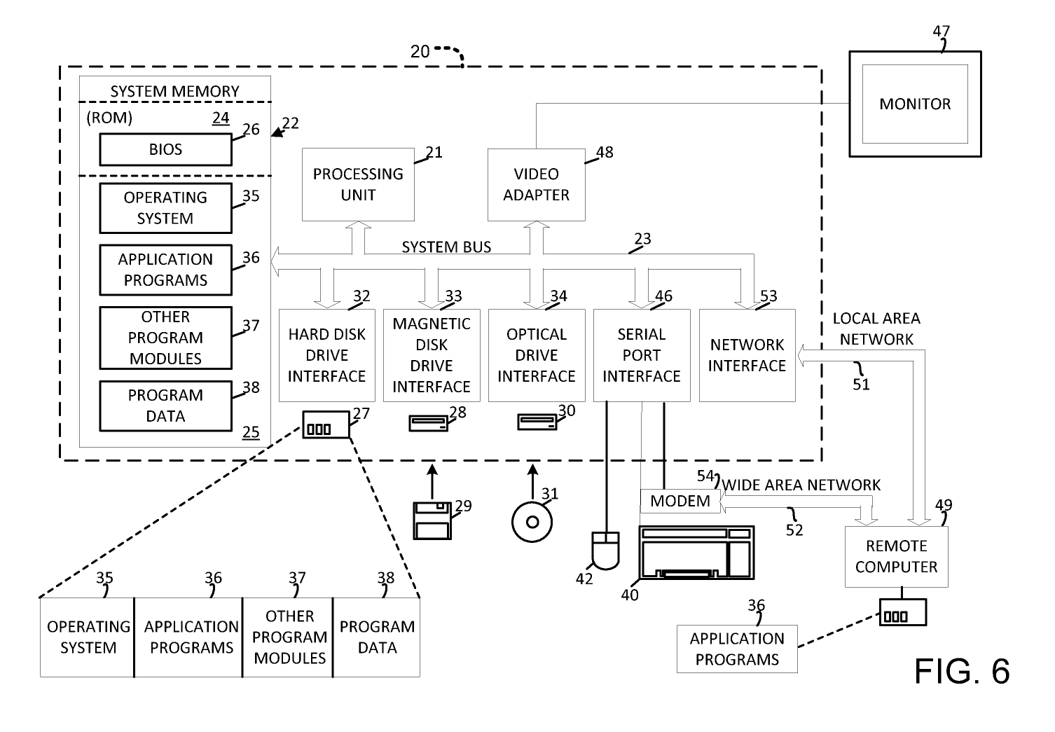

FIG. 6 illustrates an example system that may be useful in implementing the described technology. The example hardware and operating environment of FIG. 6 for implementing the described technology includes a computing device, such as general purpose computing device in the form of a gaming console or computer 20, a mobile telephone, a personal data assistant (PDA), a set top box, or other type of computing device. In the implementation of FIG. 6, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 6. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, software or firmware instructions and data for providing a window management system, a deferred placement prompt, a notification, window placement parameters and other data may be stored in memory 22 and/or storage devices 29 or 31 and processed by the processing unit 21. The window placement parameters and other data may be stored in memory 22 and/or storage devices 29 or 31 as persistent datastores.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A method comprising:
presenting a deferred placement prompt in a user interface, the deferred placement prompt being associated with presentation of an application window into the user interface;
receiving a directional placement instruction associated with the deferred placement prompt; and
presenting the application window in the user interface based on the directional placement instruction.

2. The method of claim 1 further comprising:
displaying the application window in the user interface in place of another application window indicated by the deferred placement instruction.

3. The method of claim 1 further comprising:
receiving selection of a launch control associated with the application window, prior to presenting the deferred placement prompt.

4. The method of claim 1, wherein the operation of presenting the deferred placement prompt comprises:
presenting the deferred presentation prompt as a notification from an application not concurrently visible in an application window of the user interface.

5. The method of claim 1, further comprising:
receiving a selection of a notification from an application not concurrently visible in an application window of the user interface, prior to presenting the deferred placement prompt.

6. The method of claim 1, wherein the directional placement instruction includes a drag of the deferred placement prompt.

7. The method of claim 1, wherein the directional placement instruction includes keyboard input associated with the deferred placement prompt.

8. The method of claim 1, wherein the directional placement instruction includes at least one of selection of another application window to be replaced by the application window associated with the deferred placement prompt or selection of a portion of the deferred placement prompt overlaying another application window to be replaced by the application window associated with the deferred placement prompt.

9. One or more tangible computer-readable storage media encoding computer-executable instructions for executing on a computer system a computer process, the computer process comprising:
presenting a deferred placement prompt in a user interface, the deferred placement prompt being associated with presentation of an application window into the user interface;
receiving a directional placement instruction associated with the deferred placement prompt; and
presenting the application window in the user interface based on the directional placement instruction.

10. The one or more tangible computer-readable storage media of claim 9, wherein the computer process further comprises:
receiving selection of a launch control associated with the application window, prior to presenting the deferred placement prompt.

11. The one or more tangible computer-readable storage media of claim 9, wherein the operation of presenting the deferred placement prompt comprises:
presenting the deferred presentation prompt as a notification from an application not concurrently visible in an application window of the user interface.

12. The one or more tangible computer-readable storage media of claim 9, wherein the computer process further comprises:
receiving a selection of a notification from an application not concurrently visible in an application window of the user interface, prior to presenting the deferred placement prompt.

13. The one or more tangible computer-readable storage media of claim 9, wherein the directional placement instruction includes a drag of the deferred placement prompt.

14. The one or more tangible computer-readable storage media of claim 9, wherein the directional placement instruction includes selection of two other visible application windows between which the application window is inserted within the user interface.

15. The one or more tangible computer-readable storage media of claim 9, wherein the directional placement instruction includes selection of another application window to be replaced by the application window associated with the deferred placement prompt.

16. The one or more tangible computer-readable storage media of claim 9, wherein the directional placement instruction includes at least one of selection of another application window to be replaced by the application window associated with the deferred placement prompt or selection of a portion of the deferred placement prompt overlaying another application window to be replaced by the application window associated with the deferred placement prompt.

17. A system comprising:
a computing device presenting a user interface;
a window management system configured to present a deferred placement prompt in the user interface, the deferred placement prompt being associated with presentation of an application window into the user interface and to present the application window in the user interface based on a directional placement instruction received in associated with the deferred placement prompt.

18. The system of claim 17, wherein the window management system is further configured to receive selection of a launch control associated with the application window, prior to presenting the deferred placement prompt.

19. The system of claim 17, wherein the directional placement instruction includes a drag of the deferred placement prompt.

20. The system of claim 17, wherein the window management system is configured to present the application window by displaying the application window in the user interface in place of another application window indicated by the deferred placement instruction.
